(19) United States
(12) Patent Application Publication
(10) Pub. No.: US 2004/0114636 A1
(43) Pub. Date: Jun. 17, 2004

(54) Asynchronous data multiplexer

(75) Inventor: Hermann Gysel, Cambria, CA (US)

Correspondence Address: MAYER, FORTKORT & WILLIAMS, PC, 251 NORTH AVENUE WEST, 2ND FLOOR, WESTFIELD, NJ, 07090, US

(73) Assignee: General Instrument Corporation

(21) Appl. No.: 10/319,240

(22) Filed: Dec. 13, 2002

(51) Int. Cl. H04J 3/04

(52) U.S. Cl. 370/535

(57) ABSTRACT

A method and apparatus for multiplexing high bandwidth data signals uses a bank of sampling device, such as flip-flops, on the transmission side to essentially synchronize the data prior to multiplexing the data. The method and apparatus operate at the expense of increased jitter in the received signal, which is compensated for by proper choice of the clock and data recovery circuit in the receiver. By matching the increased jitter at the transmission side with a clock recovery circuit that can process this increased jitter, a truly simply and economical asynchronous multiplexing technique and apparatus can be constructed. By using a sampling device, such as a flip-flop, and several dividers, frame synchronization bits can be added to one channel to enable proper channel alignment at the receiving end.

### FIELD OF THE INVENTION

The present invention is directed generally to methods and apparatuses for processing digital signals, and more particularly to a method and apparatus for processing digital signals in which multiple digital signals are multiplexed into a single data stream for transmission over a communications link and then demultliplexed for routing to desired locations.

### BACKGROUND

Many digital signals are processed and multiplexed in a synchronous manner. However, synchronous processing and multiplexing requires careful management of clock sources. Consequently, synchronous processing can be significantly expensive. Therefore, many digital transmission systems operate asynchronously.

While more inexpensive than synchronous multiplexers, existing synchronous multiplexers for high bandwidth data are still too expensive for certain applications. Examples of such applications include video on-demand, networked video games and other services that require delivery of large amounts of content for entertainment purposes only. For video on-demand services to even compete with movie rental stores and the like, these services must reduce costs. Therefore, either synchronous multiplexing must be performed in a significantly less expensive manner or asynchronous high-bandwidth processing multiplexing must be accomplished in a cost-effective manner.

The present invention is therefore directed to the problem of developing a method and apparatus for multiplexing high bandwidth data in an economical manner, which operates with sufficient quality for video on-demand and similar services.

### SUMMARY OF THE INVENTION

The present invention solves these and other problems by providing a method and apparatus for multiplexing high bandwidth data signals using a bank of sampling devices, such as flip-flops, on the transmission side to essentially synchronize the data prior to multiplexing the data in combination with a simple bit framing technique also employing an inexpensive sampling device, e.g., a flip-flop. This method and apparatus operate at the expense of increased jitter in the received signal, which is compensated for by proper choice of the clock and data recovery circuit in the receiver. By matching the increased jitter at the transmission side with a clock recovery circuit that can process this increased jitter, a truly simply and economical asynchronous multiplexing technique and apparatus can be constructed.

According to another aspect of the present invention, exemplary embodiments of a transmitter and receiver are also disclosed.

According to yet another aspect of the present invention, an exemplary embodiment of a method for synchronizing multiple asynchronous signals prior to transmission is disclosed. According to this embodiment, each of the asynchronous signals is first sampled with a sampling device, such as a flip-flop. Furthermore, each of the sampling devices or flip-flops is clocked with a clock having a clock rate in excess of almost twice (e.g., about 1.7 times) the data rate of each of the asynchronous signals. In addition, a simple bit framing insertion technique is employed using one of the sampling devices or flip-flops on one channel to permit proper channel alignment.

According to still another aspect of the present invention, an exemplary embodiment for coupling multiple asynchronous signals to a communications link is disclosed. According to this embodiment, each of the asynchronous signals is first coupled to a sampling device, such as a flip-flop. The output of each of the sampling devices or flip-flops is then coupled to a multiplexer. Frame alignment bits are inserted into one channel of the input using a sampling device, such as a flip-flop, and a bit toggle technique. Each of the outputs of the sampling devices or flip-flops is multiplexed into a combined signal. The combined signal is then coupled to the communications link.

Further aspects of the present invention will be apparent upon review of description herein in light of the following drawings.

### BRIEF DESCRIPTION OF THE DRAWINGS

FIG. 1 depicts a block diagram of an exemplary embodiment of an apparatus for transmitting multiple data streams over a communication link according to one aspect of the present invention.

FIG. 2 depicts a flow chart of an exemplary embodiment of a method for synchronizing multiple asynchronous signals prior to transmission according to another aspect of the present invention.

FIG. 3 depicts a flow chart of an exemplary embodiment of a method for coupling multiple asynchronous signals to a communications link according to still another aspect of the present invention.

FIG. 4 depicts a block diagram of an exemplary embodiment of an apparatus for inserting frame synchronization bits in one channel of the input data according to yet another aspect of the present invention.

FIG. 5 depicts a block diagram of an exemplary embodiment of an apparatus for detecting the frame synchronization bits according to still another aspect of the present invention.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

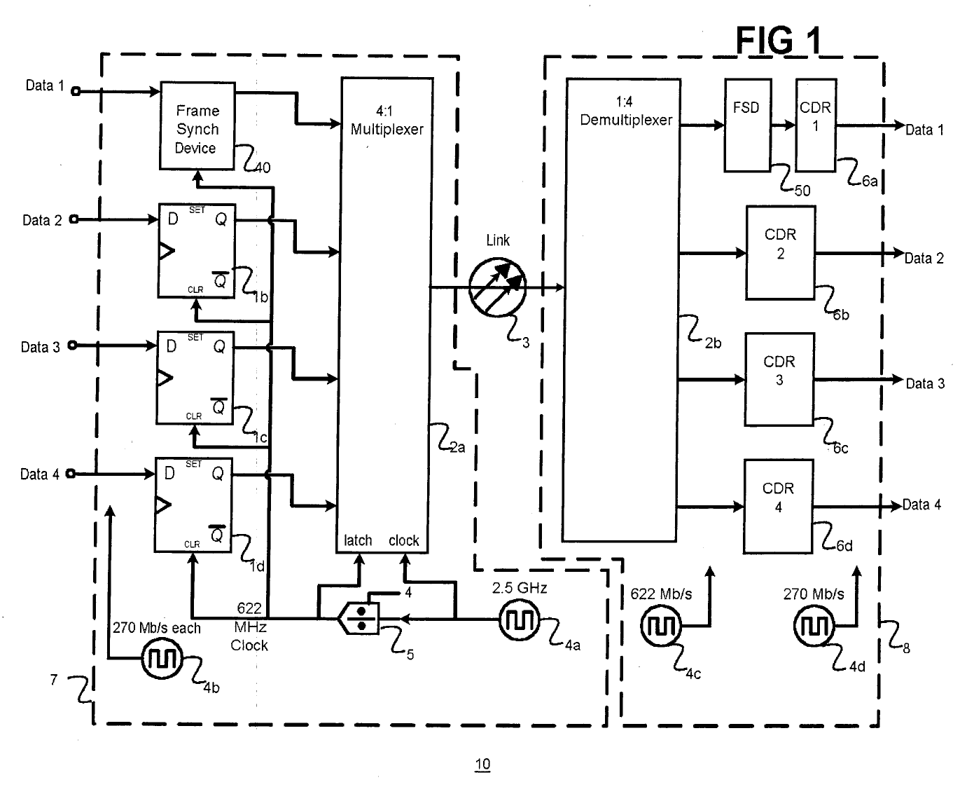

Referring to FIG. 1, shown therein is an exemplary embodiment 10 of an apparatus for transmitting multiple signals over a single communications link as a single high bandwidth signal. In this embodiment 10, there are four signals multiplexed into the single high bandwidth signal, however, the techniques herein can easily be extended to larger numbers of signals, such as eight, sixteen, thirty-two, etc. Moreover, these techniques can even be applied to one, two or three signals as well. At a high level of functionality, the embodiment 10 includes a transmitter 7, a communications link 3 and a receiver 8.

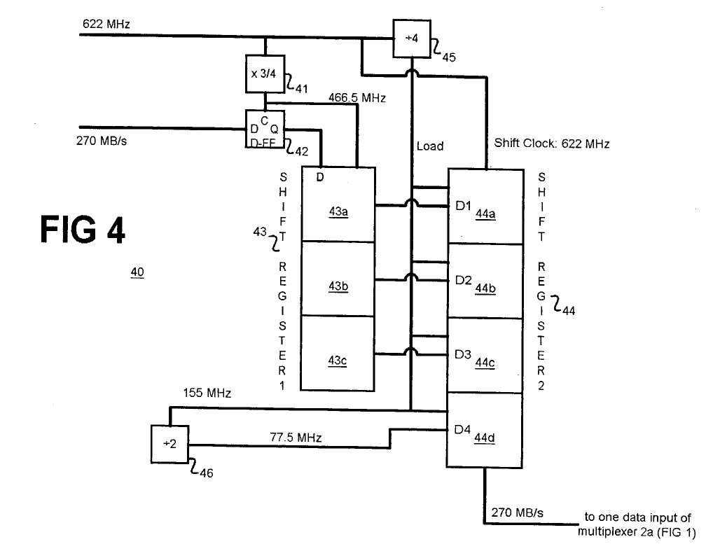

Within the transmitter 7, a bank of sampling devices, e.g., flip-flops, 1b-d and one frame synchronization device 40 acts to synchronize the incoming data signals (D1-D4). The functionality of the frame synchronization device 40 will be explained vis-à-vis FIG. 4 below. Essentially, however, frame synchronization device 40 includes a sampling device, such as a flip-flop, at its center that operates similarly to sampling devices or flip-flops 1b-1d with regard to the input data signal.

These flip-flops 1b-d can be D flip-flops or other types. An exemplary embodiment of these flip-flops includes a flip-flop available from ON Semiconductor, part number MC10EL31. One flip-flop is employed for each signal being multiplexed, so for example, in a sixteen signal multiplexer there would be a bank of sixteen flip-flops (however, at least one or more flip-flops may be replaced with the frame synchronization device 40).

The flip-flops 1b-d and frame synchronization device 40 sample the incoming signal at three possible locations on the data pulse—the “one” position, the “zero” position or in the transition region (i.e., either transitioning from zero to one or from one to zero). Thus, by selecting the clock properly one can ensure sufficient samples are being obtained. Hence, the output of each flip-flop will be a 1, a 0 or a random value.

Thus, the embodiment shown herein will synchronize the incoming signals to be multiplexed in a very simple and economical manner, but at the expense of increased jitter in the received signal. The increased jitter results from the additional random values output when the flip-flops sample the incoming signals during a transition region.

The outputs of the flip-flops 1b-d and frame synchronization device 40 are coupled to a four-to-one (4:1) multiplexer 2a, which creates a single combined signal from the four inputs. Any standard multiplexer can be employed, as the signals are now synchronous. An example of a suitable multiplexer includes the Intel multiplexer GD16553.

The combined signal is then transmitted over a communications link 3, such as a fiber optic cable, a coaxial cable, or some hybrid fiber coaxial cable. Other activities that can be modeled as a communications link are also possible, such as data writing and reading to a memory device, such as a hard drive, thereby making the embodiments herein applicable to these types of applications as well.

On the receiver side, at the end of the communications link 3 is a one-to-four (1:4) demultiplexer 2b, which converts the incoming signal to its constituent elements. The demultiplexer 2b is matched to the multiplexer 2a. So, if N signals are being multiplexed in the transmitter, then N signals are demultiplexed by a N:1 demultiplexer in the receiver. Standard demultiplexers can be used, such as the Intel GD16553.

The outputs of the demultiplexer are then coupled to four Clock and Data Recovery (CDR) circuits 6a-d, which recreate the original data signals (D1-D4). One output is first passed through a frame synchronization device 50 before being coupled to its respective CDR, which synchronization device detects the frame synchronization bits that are used to align the various channels. Once the synchronization bits are detected, the alignment of the channels is performed in the standard manner.

Any increased jitter can be accommodated by proper selection of the clock and data recovery circuit in the receiver. Simply put, one must employ a clock and data recovery circuit that can handle more jitter than a typical synchronous communications system. Such circuits are available, for example, an adequate clock and data recovery circuit is the SY87701 CDR by Micrel.

At the center of the embodiment 10 is a clock source 4a, which in this embodiment is a 2.5 GHz clock, which clocks the multiplexer 2a. A divider 5 converts the clock signal to a 622 MHz clock, which clocks the D flip-flips 1a-d and is input to a latch input of multiplexer 2a. The data rate of the incoming signals is about 270 Mb/s (shown symbolically as clocked by a clock 4b on the input side and clock 4d on the output side). The data rate of the signals being output by the demultiplexer 2b is about 622 Mb/s (shown symbolically as clocked by a clock 4c).

Thus, the exemplary embodiment 10 operates as follows. A 2.5 GHz clock drives the 4:1 multiplexer, which receives four data streams of 622 Mb/s. These data streams are generated by sampling four 270 Mb/s data streams at 622 MHz. The 622 Mb/s signal is jittered with respect to 270 MHz, but not with respect to 622 MHz. If the sampling clock is twice the data rate of the signal being sampled, then there is a jitter width of 50%. A clock and data recovery (CDR) circuit in the receiver removes this jitter. With twice the data rate there is a jitter of 50% of the clock cycle. The eye closes completely with the sampling frequency being equal to the data rate of the signal to be sampled (which is the equivalent of the Nyquist limit called the sampling theorem). Therefore, sampling rates, which are lower than exactly twice the data rate are possible. A good practical number is 1.7 times the data rate (or ca. twice the data rate).

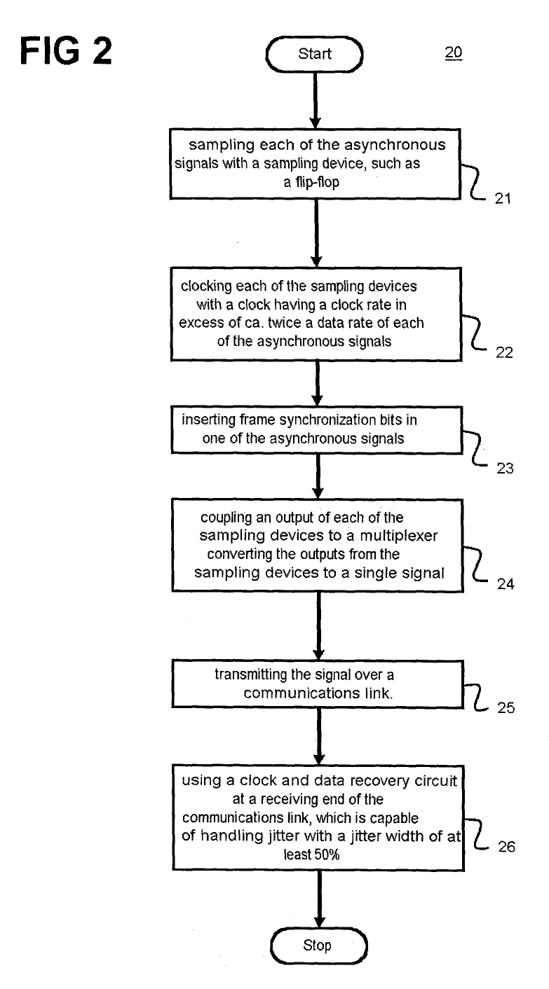

Turning to FIG. 2, shown therein is an exemplary embodiment 20 of a method for synchronizing multiple asynchronous signals prior to transmission. According to this embodiment 20, each of the asynchronous signals is sampled with a sampling device, such as a flip-flop (element 21). Furthermore, each of the sampling devices or flip-flops is clocked with a clock having a clock rate in excess of ca. twice (e.g., about 1.7 times) the data rate of each of the asynchronous signals (element 22). Frame synchronization buts are inserted into one of the asynchronous signals (element 23). An output of each of the sampling devices or flip-flops is coupled to a multiplexer converting the outputs from the plurality of sampling devices or flip-flops to a single signal (element 24). The single signal is then transmitted over a communications link (element 25). A clock and data recovery circuit is then used at a receiving end of the communications link, which clock and data recovery circuit is capable of handling jitter with a jitter width of at least 50% or more (element 26).

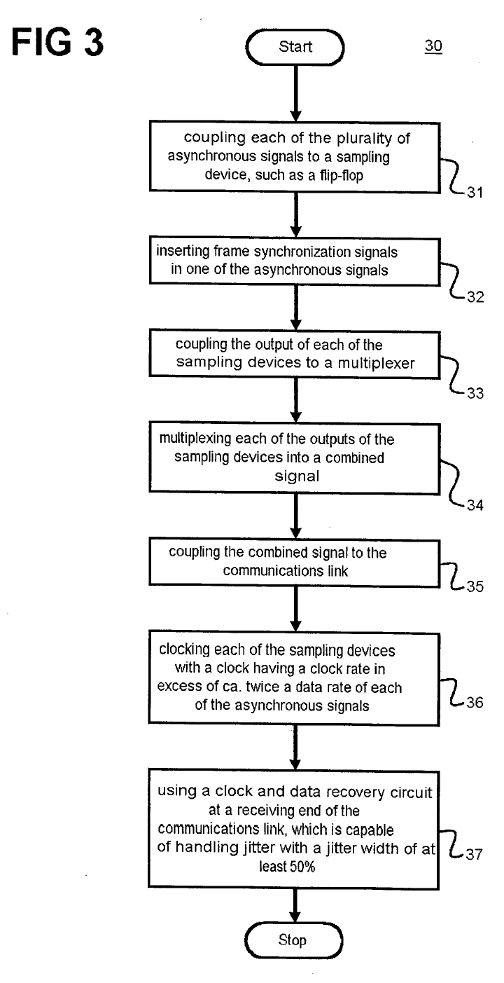

Turning to FIG. 3, shown therein is an exemplary embodiment 30 of a method for coupling multiple asynchronous signals to a communications link. According to this embodiment, each of the asynchronous signals is coupled to a sampling device, such as a flip-flop (element 31). Frame synchronization bits are inserted into one of the asynchronous signals (element 32). The output of each of the sampling devices or flip-flops is then coupled to a multiplexer (element 33). Each of the outputs of the sampling devices or flip-flops is multiplexed into a combined signal (element 34). The combined signal is then coupled to the communications link (element 35). Each of the sampling devices or flip-flops is clocked with a clock having a clock rate in excess of ca. twice a data rate of each of the asynchronous signals (element 36). A clock and data recovery circuit is used at a receiving end of the communications link, which clock and data recovery circuit is capable of handling jitter with a jitter width of at least 50% or more (element 37).

The present invention thus provides an extremely inexpensive yet effective technique for performing asynchronous communications. The D flip-flops set forth herein are very inexpensive parts, e.g., on the order of $2 per part. This avoids the costly and complex synchronization circuits.

Adding Frame Synchronization

Frame synchronization is needed for the recognition of the order of bits in the serial bit stream. In order to do that, every fourth bit of one 622 MB/s bit stream is a synchronization bit. One approach is to use a toggle bit as the synchronization bit. On the receive side, it is sufficient to recognize which bit toggles in order to identify the order of the payload bits. See the block diagram of an exemplary embodiment 40 of the frame synchronization apparatus shown in FIG. 4.

The embodiment 40 shown in FIG. 4 is included in the transmitter 7 in lieu of one of the flip-flops 1a-1d as shown in FIG. 1. The output of embodiment 40 provides one of the inputs of the 4:1 multiplexer 2a. The input of embodiment 40 is one of the data inputs shown as input to one of the flip-flops 1a-1d in FIG. 1.

The remaining three data inputs (270 Mb/s each) remain unchanged. Thus, one of the four data inputs to the bank of flip-flops 1a-1d includes a frame synchronization bit, the recognition of which will allow proper allocation of the data to the at the receive end.

The 622 MHz clock (which is available in the transmitter 7 from clock 4a that has been divided by 4 by divider 5, see FIG. 1) is further divided by 4 (in divider 45) in order to obtain a 155 MHz clock signal. The 622 MHz clock is then sent through an x¾ multiplier 41 as well to produce a 466.5 MHz clock signal. A D-Flip-Flop 42 samples the asynchronous 270 MB/s data at a clock speed of 466.5 MHz. A following shift register 43, which is clocked at 466.5 MHz as well, loads three samples into cells 43a-c, respectively. The 155 MHz clock loads the first three cells (44a-c) of the second shift register 44 with the three data samples of the first shift register 43. The 4th cell (44d) of the second shift register 44 is loaded with the toggle bit (e.g., the frame synchronization bit). The toggle bit is obtained by dividing the 622 MHz clock signal by two in divider 46. The second shift register 44 is then clocked out at 622 MHz, thereby producing a serial bit stream of the original data signal that contains three bits of the original payload data and one bit of synchronization at the data rate of 622 MB/s. This serial bit stream fits into the 4×622 MB/s transport scheme discussed above, which runs at 2.48 GB/s.

Frame Synchronization at the Receive Side

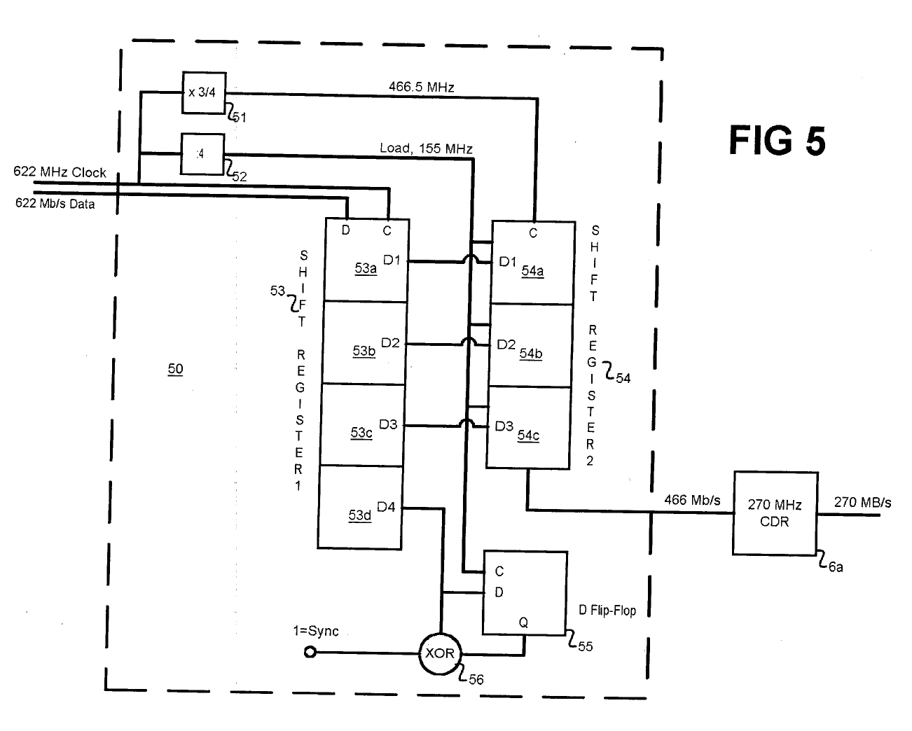

Turning to FIG. 5, shown therein is an exemplary embodiment 50 of the frame synchronization device (FSD) according to one aspect of the present invention. The received 622 MHz clock is processed into a 155 MHz clock signal and a 466.5 MHz clock signal by divider 52 and multiplier 51, respectively. A first shift register 53 is loaded with the serial 622 Mb/s data at a clock rate of 622 MHz. The 155 MHz clock loads the second shift register 54, which is read out at a rate of 466.5 MHz. The third bit of the second shift register 54 represents the sampled version of the original 270 MB/s data stream. A low jitter Clock and Data Recovery circuit 6a removes the sample jitter.

The fourth bit of the first shift register 53 is clocked into a D-Flip-Flop 55. The present and previous value is compared in an X-OR gate 56, where the situation is detected, when both values are always of opposite sign, as is the case in a toggle sequence. That information is used to synchronize the position of the four data signals of the 2.48 GB/s data stream in the normal manner, thereby resulting in the correct assignment of the channel numbers.

### SUMMARY

Although various embodiments are specifically illustrated and described herein, it will be appreciated that modifications and variations of the invention are covered by the above teachings and are within the purview of the appended claims without departing from the spirit and intended scope of the invention. For example, certain types of flip-flops are discussed in the embodiments; however, other types may be sufficient to practice the inventions herein. Furthermore, these examples should not be interpreted to limit the modifications and variations of the invention covered by the claims but are merely illustrative of possible variations.

What is claimed is:

1. A communications system for communicating a plurality (N) of data signals comprising:
a transmitter including:
a plurality (N-k) of sampling devices, each sampling device receiving one of the plurality of data signals and each sampling device having an output;
one or more frame synchronization devices (k) receiving one or more other ones (k) of the plurality of data signals that are not coupled to any of the plurality of sampling devices, each of said one or more frame synchronization devices adding frame synchronization bits to one of said one or more other ones (k) of the plurality of data signals and each of said one or more frame synchronization devices having an output;
an N:1 multiplexer having a first plurality (N-k) of inputs, each of which is coupled to one output of the plurality of sampling devices, having one or more other inputs (k) coupled to the one or more outputs of the one or more (k) frame synchronization devices, said N:1 multiplexer creating a combined signal from the outputs of the plurality of sampling devices and the one or more outputs of the one or more frame synchronization devices; and
a receiver coupled to the transmitter and including:
a 1:N demultiplexer receiving the combined signal, converting the combined signal to a plurality (N) of demultiplexed signals and having a plurality of outputs, one for each of the plurality (N) of demultiplexed signals;
one or more (k) frame synchronization detectors coupled to one or more outputs of the 1:N demultiplexer, each of said one or more frame synchronization detectors associated with one of said one or more other inputs (k) of the N:1 multiplexer to which the one or more frame synchronization devices are coupled, each of said one or more frame synchronization detectors detecting frame synchronization bits in one of said one or more outputs (k) of the 1:N demultiplexer, each of said one or more frame synchronization detectors having a data output and each of said one or more frame synchronization detectors outputting a frame synchronization detection signal;
a first plurality (N-k) of clock and data recovery circuits, one for each of the plurality (N-k) of sampling devices, each of said first plurality (k) of clock and data recovery circuits being coupled to one of the plurality of outputs of the 1:N demultiplexer and recreating one of the plurality (N) of data signals from one of the plurality of demultiplexed signals; and
one or more (k) additional clock and data recovery circuits, one for each of the one or more (k) frame synchronization detectors, each of said one or more additional (k) clock and data recovery circuits coupled to one of the plurality of outputs of the 1:N demultiplexer and recreating one of the plurality of data signals from one of the plurality of demultiplexed signals.

2. The system according to claim 1, wherein the plurality of sampling devices comprises a plurality of flip-flops.

3. The system according to claim 1, further comprising a clock being coupled to the transmitter.

4. The system according to claim 1, further comprising a first clock outputting a first clock signal and a divider coupled to the first clock and outputting a second clock signal lower than the first clock signal, wherein the second clock signal drives each of the plurality (N-k) of sampling devices, the one or more frame synchronization devices, and the N:1 multiplexer.

5. The system according to claim 4, wherein the second clock signal is at least 1.7 times as fast as a data rate of each of the plurality of data signals.

6. The system according to claim 1, wherein each of the one or more frame synchronization devices includes:
a first divider receiving a first clock signal and dividing the first clock signal by a first predetermined number and outputting a first modified clock signal;
a second divider receiving the first clock signal and dividing the first clock signal by a second predetermined number and outputting a second modified clock signal;
a first multiplier receiving the first clock signal and multiplying the first clock signal by a first predetermined number and outputting a third modified clock signal;
a first sampling device receiving said one of the one or more other ones of the plurality of data signals, having a clock input receiving the third modified clock signal and having a data output;
a first shift register including a plurality of registers (M-1), said first shift register having a data input coupled to the data output of the first sampling device, having a clock input receiving the third modified clock signal and having an output for each of the plurality (M-1) of registers; and
a second shift register including a plurality of registers (M), each of said plurality of registers having a load input receiving the first modified clock signal, all but one of said plurality of registers having a data input coupled to one output of the plurality (M-1) of registers of the first shift register, said one of said plurality (M) of registers having a data input receiving the second modified clock signal, said second shift register having a data output outputting a modified data signal embedded with a plurality of frame synchronization bits.

7. The system according to claim 1, wherein the frame synchronization detector includes:
a multiplier receiving a first clock signal, multiplying the first clock signal by a predetermined value and outputting a first modified clock signal;
a divider receiving the first clock signal, dividing the first clock signal by a predetermined value and outputting a second modified clock signal;
a first shift register having a plurality (M) of registers, having a clock input receiving a first clock signal, having a data input receiving the combined signal, having a data output for each of the plurality of registers;
a second shift register having a plurality (M-1) of registers, each of the plurality of registers having a clock input receiving the first modified clock signal, having a load input receiving the second modified clock signal, having a data input coupled to the data output of one of the plurality of registers of the first shift register, said second shift register having a data output outputting the combined signal;
a first sampling device having a clock input receiving the second modified clock signal, having a data input coupled to a data output of one of the registers of the plurality of registers of the first shift register, and having a data output, wherein the data output of said one register of the plurality of registers of the first shift register is not coupled to any data input of the plurality of registers of the second shift register; and
an exclusive OR gate having a first input coupled to the data output of said one register of the plurality of registers of the first shift register, having a second input coupled to the data output of the first sampling device and outputting an exclusive-ORed value.

8. An apparatus for transmitting a plurality (N) of data signals comprising:
a plurality (N-k) of sampling devices, each sampling device receiving one of the plurality of data signals and each sampling device having an output;
one or more frame synchronization devices (k) receiving one or more other ones (k) of the plurality of data signals that are not coupled to any of the plurality of sampling devices, each of said one or more frame synchronization devices adding frame synchronization bits to one of said one or more other ones (k) of the plurality of data signals and each of said one or more frame synchronization devices having an output; and
an N:1 multiplexer having a first plurality (N-k) of inputs, each of which is coupled to one output of the plurality of sampling devices, having one or more other inputs (k) coupled to the one or more outputs of the one or more (k) frame synchronization devices, said N:1 multiplexer creating a combined signal from the outputs of the plurality of sampling devices and the one or more outputs of the one or more frame synchronization devices.

9. The apparatus according to claim 8, further comprising a receiver coupled to the transmitter.

10. The apparatus according to claim 9, wherein the receiver further comprises a 1:N demultiplexer receiving the combined signal, converting the combined signal to a plurality (N) of demultiplexed signals and having a plurality of outputs, one for each of the plurality (N) of demultiplexed signals.

11. The apparatus according to claim 9, wherein the receiver further comprises a first plurality (N-k) of clock and data recovery circuits, one for each of the plurality (N-k) of sampling devices, each of said first plurality (k) of clock and data recovery circuits being coupled to one of the plurality of outputs of the 1:N demultiplexer and recreating one of the plurality (N) of data signals from one of the plurality of demultiplexed signals.

12. The apparatus according to claim 11, wherein the receiver comprises one or more (k) frame synchronization detectors coupled to one or more outputs of the 1:N demultiplexer, each of said one or more frame synchronization detectors associated with one of said one or more other inputs (k) of the N:1 multiplexer to which the one or more frame synchronization devices are coupled, each of said one or more frame synchronization detectors detecting frame synchronization bits in one of said one or more outputs (k) of the 1:N demultiplexer, each of said one or more frame synchronization detectors having a data output and each of said one or more frame synchronization detectors outputting a frame synchronization detection signal;

13. The apparatus according to claim 12, wherein the receiver further comprises one or more (k) additional clock and data recovery circuits, one for each of the one or more (k) frame synchronization detectors, each of said one or more additional (k) clock and data recovery circuits coupled to one of the plurality of outputs of the 1:N demultiplexer and recreating one of the plurality of data signals from one of the plurality of demultiplexed signals.

14. The apparatus according to claim 8, wherein the plurality of sampling devices comprises a plurality of flip-flops.

15. The apparatus according to claim 8, further comprising a clock being coupled to the transmitter.

16. The apparatus according to claim 8, further comprising a first clock outputting a first clock signal and a divider coupled to the first clock and outputting a second clock signal lower than the first clock signal, wherein the second clock signal drives each of the plurality (N-k) of sampling devices, the one or more (k) synchronization devices and the N1 multiplexer.

17. The apparatus according to claim 16, wherein the second clock signal is at least 1.7 times as fast as a data rate of each of the plurality of data signals.

18. A method for synchronizing a plurality of asynchronous signals prior to transmission comprising:
sampling each of the plurality of asynchronous signals with a sampling device;
clocking each of the sampling devices with a clock having a clock rate in excess of twice a data rate of each of the plurality of asynchronous signals; and
inserting frame synchronization bits in one of the plurality of asynchronous signals.

19. The method according to claim 18, further comprising coupling an output of each of the sampling devices to a multiplexer converting the outputs from the plurality of sampling devices to a single signal.

20. The method according to claim 19, wherein the sampling device comprises a flip-flop.

21. The method according to claim 20, further comprising using a clock and data recovery circuit at a receiving end of the communications link, which clock and data recovery circuit is capable of handing jitter with a jitter width of at least 50%.

22. A method for coupling a plurality of asynchronous signals to a communications link comprising:
coupling each of the plurality of asynchronous signals to a sampling device;
inserting frame synchronization signals in one of the plurality of asynchronous signals;
coupling the output of each of the sampling devices to a multiplexer;
multiplexing each of the outputs of the sampling devices into a combined signal; and
coupling the combined signal to the communications link.

23. The method according to claim 22, further comprising clocking each of the sampling devices with a clock having a clock rate in excess of about 1.7 times a data rate of each of the plurality of asynchronous signals.

24. The method according to claim 23, further comprising using a clock and data recovery circuit at a receiving end of the communications link, which clock and data recovery circuit is capable of handing jitter with a jitter width of at least 50%.

25. The method according to claim 22, wherein the sampling device comprises a flip-flop.
